(19) United States
(12) Patent Application Publication
(10) Pub. No.: US 2010/0208247 A1
(43) Pub. Date: Aug. 19, 2010

(54) Quality assurance testing for rotor blades of a wind energy installation

(76) Inventors: Thomas Bosselmann, Marloffstein (DE); Hagen Hertsch, Erlangen (DE); Joachim Kaiser, Erlangen (DE); Nils-Michael Theune, Oberasbach (DE); Michael Willsch, Jena (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/703,916

(22) Filed: Feb. 11, 2010

(30) Foreign Application Priority Data
Feb. 17, 2009 (DE) 10 2009 009 272.2

(51) Int. Cl. G01N 21/88

(52) U.S. Cl. 356/237.1

(57) ABSTRACT

To check whether the glass fiber or carbon fiber mats in a rotor blade for a wind energy installation have faults, upward bulges or folds after they have been manufactured, a point or line laser is directed at an angle onto the surface of the rotor blade. From the position of the reflected beam, especially a proportion of the beam that is reflected below the surface of the rotor blade at the mat, the location and form of the mat is deduced and it is determined in a non-destructive manner whether faults, upward bulges or folds are present.

### CROSS REFERENCE TO RELATED APPLICATIONS

This application claims priority of German application No. 10 2009 009 272.2 DE filed Feb. 17, 2009, which is incorporated by reference herein in its entirety.

### FIELD OF INVENTION

The invention relates to a method and also to an apparatus for testing the manufacturing quality of a rotor blade of a wind energy installation. In particular the properties of the rotor blade not visible from outside are considered in such cases.

### BACKGROUND OF INVENTION

The properties of the rotor blades of a wind energy installation are important for the energy yield of the wind energy installation. Currently rotor blades are mainly manufactured from glass-reinforced plastic (GRP). The lengths of the rotor blades used extend in such cases from a few meters up to 60 m and more. The significant longitudinal forces occurring during operation are taken up by one or more belts or tracks made of glass fiber or carbon fiber—referred to below as fiber mats. The belts are either made of continuous fibers, the so-called rovings, or are unidirectional fabrics.

During manufacturing the tracks of glass fiber or carbon fiber are laid into a negative mold for a rotor blade. Then the negative mold is filled with an epoxy resin and the resin is hardened.

Ideally the fiber mats lie smoothly embedded into the rotor blade after the rotor blade has been manufactured. In actual fact the tracks exhibit upward bulges and folds however. Such an Omega-shaped folding is shown schematically in FIG. 1 In the area of such a fold it is not guaranteed that the longitudinal forces which act on the rotor blade will be taken up in the desired way. In general terms the bulges and folds weaken the rigidity and elasticity desired and intended for the rotor blade, especially in the longitudinal direction of the rotor blade, i.e. along its longest extent. These faults in the structure of the rotor blade can lead to sudden failure, or to formulate the problem in general terms, to a reduction in the lifetime of the rotor blade.

### SUMMARY OF INVENTION

The opaque material of rotor blades generally does not allow any post-production visual inspection of a rotor blade. The object of the present invention is thus to specify an apparatus and a method for testing the manufacturing quality for a rotor blade of a wind energy installation with which faults in the fiber mats embedded in the rotor blade can be checked in a non-destructive and simple manner.

The object is achieved by an apparatus and a method with the features of the independent claims. The dependent claims relate to advantageous embodiments of the invention.

The inventive apparatus for testing the manufacturing quality for a rotor blade of a wind energy installation has at least one light source for emission of light. Preferably the light source involves a laser light source, for example a laser diode. In this case the emitted light involves laser light with its known properties. However a light emitting diode can also be used for example. The apparatus also includes a detection device for detection of the light. The detection device is position-sensitive in this case, meaning that it possesses a local resolution in at least one dimension. In other words the detection device is in a position to be able to determine a light beam arriving in at least one dimension. Typical detection devices employed here are a row of photodiodes or a camera, based on a CCD for example. The detection device is arranged outside the light path of the light. In other words the light from the light source does not strike the detection device unless it is deflected.

In the inventive method for testing the manufacturing quality for a rotor blade of a wind energy installation light is beamed onto the rotor blade at an angle other than at right angles to its surface. Light reflected from the rotor blade is received by a detector. When this occurs, the position of light reflected on a fiber mat below the surface of the rotor blade is determined at the detector and the location of the fiber mat is determined from the position. In such cases the depth of the reflection below the surface of the rotor blade is expediently deduced from the position on the detector.

To simplify this deduction it is advantageous if, in addition to the position of light reflected from below the surface of the rotor blade on a fiber mat, a basic position is also determined, with the basic position being the position of light on the detector reflected directly on the surface of the rotor blade. The position can then be compared with the basic position in order to determine from said comparison the depth below the surface at which the reflection has occurred.

In an advantageous embodiment of the invention the light source is a linear light source. In other words the light source emits a beam of light which sweeps over one plane. To this end, as well as a light source which creates such light directly, a point light source with an additional optical element which takes care of spreading the beam can be used. With such a light source a plurality of points of the surface of the rotor blade can be examined simultaneously. For this purpose it is again very advantageous for the detection device to be a planar sensor. Cameras, especially a CCD (Charge Coupled Device) are typically employed for this purpose. A planar sensor is in a position to simultaneously accept the reflection of the light from the linear light source on the surface and also the reflections of the light line from below the surface of the rotor blade.

It is expedient for the position of the reflected light not only to be determined at a point or with a line, but extending over an entire area. This namely makes it possible to determine the position of the fiber mat in the area. Since it is not known in advance where the fiber mat might have a fold or a fault, it is useful to subject a rotor blade to testing wherever a fiber mat is located below the surface.

To this end it is thus of advantage for a proportion of the surface of the rotor blade to be tested with the apparatus or with the method. Expediently the rotor blade and the apparatus are displaced relative to one another for this purpose, so that over time the light beam covers the proportion of the surface to be examined. There are various alternatives for the relative displacement.

In one embodiment the rotor blade is left in a fixed position and the apparatus is moved via a displacement unit. In this case a three-dimensional displacement unit can be used to also keep the distance to the surface of the rotor blade constant. In such cases it is also advantageous for the apparatus to be able to be tilted in addition to simply being moved, in order to keep the angular relationships constant, taking into consideration the curved surface of the rotor blade.

In one alternative the rotor blade is moved by means of a displacement unit while the apparatus remains fixed in one place. This alternative is typically of advantage if a sufficiently measurable basic position is available from the reflection of the light on the surface of the rotor blade itself. In this case the depth of any other reflections can namely then be reliably specified if the distance between the apparatus and the surface changes.

In a third alternative the rotor blade is guided in a movement and rotation unit which allows a movement expediently in the longitudinal direction and simultaneously a rotation around the longitudinal axis. In this alternative the rotor blade can easily be examined in a similar way to with a rolling wheel sensor at any point of the surface. In this case it is conceivable that, when a linear light source is used, said source can be arranged so that the light line hits the rotor blade at right angles to the longitudinal direction. If the rotor blade is turned at a constant speed and, during this operation, is likewise moved at a constant speed in the longitudinal direction—this can naturally also occur in stages—the surface of the rotor blade can be examined almost seamlessly, since the light line covers the entire surface in a spiral shape.

### BRIEF DESCRIPTION OF THE DRAWINGS

Preferred, but in no way restrictive, exemplary embodiments for the invention are now explained in greater detail with reference to the drawing. The figures show schematic diagrams of the features and the corresponding features are marked with the same reference signs. Individually the figures show

FIG. 1 an Omega-shaped fault of a fiber mat in a rotor blade,

FIG. 2 a system for testing the position of fiber mats in the rotor blade,

FIG. 3 the path of reflected beams for an ideal position of the fiber mat,

FIG. 4 the path of reflected beams in the vicinity of a fault in the fiber mat,

FIG. 5 a scheme for examining the entire surface of the rotor blade,

FIG. 6 a further scheme for examining the entire surface of the rotor blade and

FIG. 7 a possible embodiment with a line laser.

### DETAILED DESCRIPTION OF INVENTION

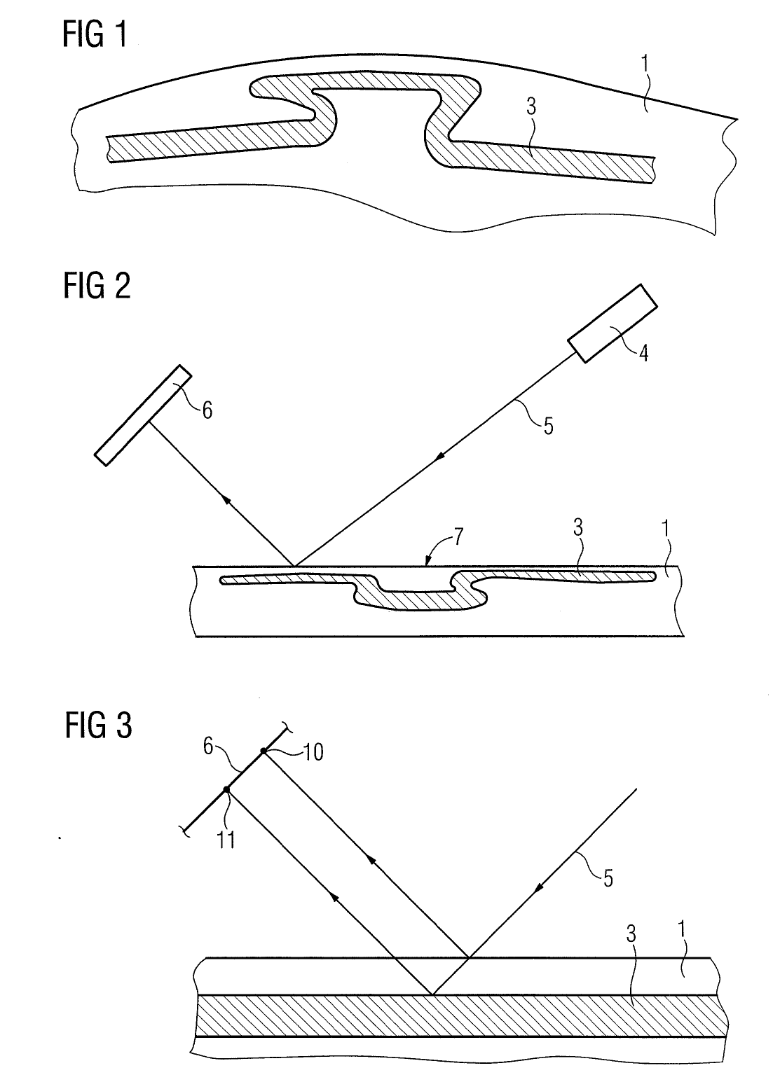

FIG. 1 shows a rotor blade 1 in cross section in the completed state with a fault of a fiber mat 3. The fault is in the shape of the letter Omega. Ideally the fiber mat 3 would have to run in an essentially straight course in order to guarantee the ideal take-up of the longitudinal forces on the rotor blade 1. In the area of the deviation from the straight course in particular the fault prevents the desired stiffness and elasticity being achieved for the rotor blade, so that the life of the rotor blade 1 is reduced. The longitudinal forces typically cover the forces arising in operation of the wind energy installation through the wind pressing on the rotor blade 1.

The fault is not visually apparent from the outside in the completed rotor blade 1 since the material for the rotor blade 1—epoxy resin—is not sufficiently transparent. However, to still be able to identify a fault as shown in FIG. 1 or other deformations of the fiber mat 3, a system in accordance with FIG. 2 can be employed, which serves as an exemplary embodiment for the invention.

In this exemplary embodiment a beam from a point laser 4 hits the surface 7 of the rotor blade 1 at an angle of around 45°. The laser light 5 of the point laser 4 is reflected at least partly from the surface 7 and then hits a detector in the form of a row of photodiodes 6. The row of photodiodes 6 is likewise arranged in accordance with the reflection on the surface 7 of the rotor blade 1 at an approximately 45° angle to this surface 7, in order to receive the reflected laser light 5. The row of photodiodes 6 is position-sensitive, i.e. it can determine the location at which the reflected laser light 5 arrives. In this case it is expedient for the row of photodiodes 6 to at least be able to resolve positional changes in the plane that is formed by the laser light 5 and the reflected laser light 5. This namely makes it possible to resolve the position changes which arise from parts of the laser light 5 being reflected at a different depth below the surface 7 of the rotor blade 1.

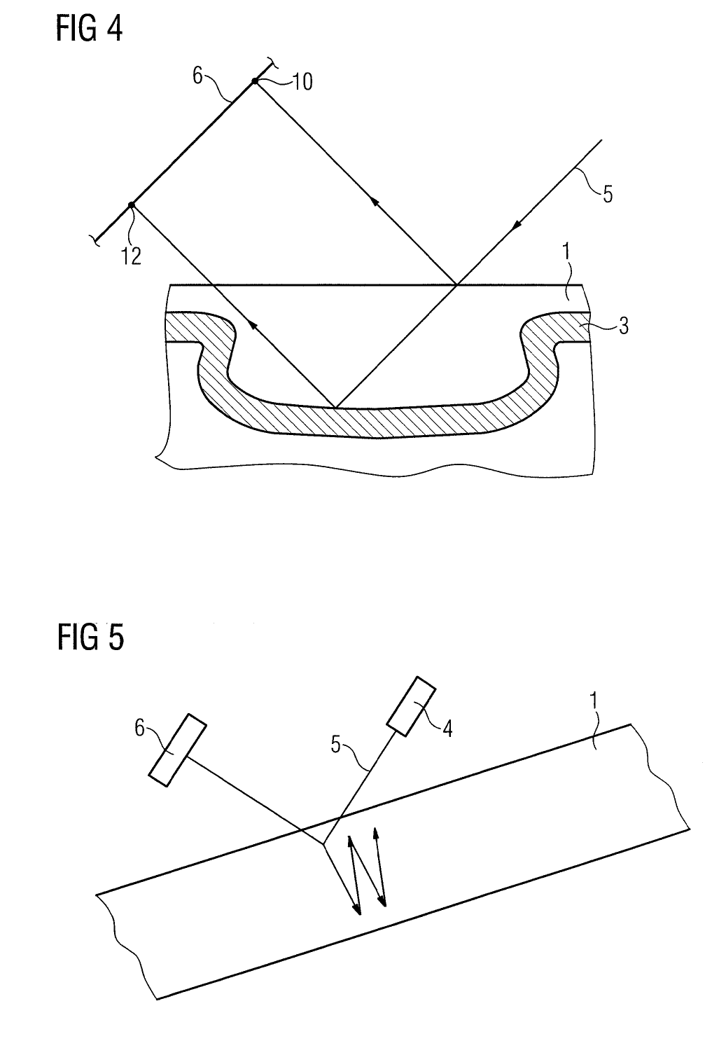

On the basis of the reflection of parts of the laser light 5 on the surface 7 and below the surface 7 of the rotor blade 1, different situations are produced which are presented in FIGS. 3 and 4. The intensity of the individual reflected proportions can vary in such cases. Thus it is also possible for a reflection of laser light 5 by the surface 7 itself to be not present or too weak to be included in the evaluation.

FIG. 3 shows the situation which is produced when the fiber mat 3 is arranged in a desired way, i.e. substantially in a straight line, below the surface 7 of the rotor blade 1. The laser light 5 is reflected in this exemplary embodiment in parts directly on the surface 7. This part of the reflected laser light 5 hits the row of photodiodes 6 at a basic position 10. A further part of the laser light 5 is only reflected below the surface 7, namely at the fiber mat 3. This part of the laser light 5, after exiting from the rotor blade 1, then hits the row of photodiodes 6 at a first position 11. For reasons of clarity no effect of the diffraction of the light is shown in FIG. 3. The diffraction of the laser light 5 at the surface 7 of the rotor blade 1 for example has effects on the first position 11 and the further positions that are produced for the reflected laser light 5.

The distance between the first position 11 and the basic position 10 depends on the location of the fiber mat 3 in the rotor blade 1, especially on the distance between the fiber mat 3 and the surface 7. Thus by observing and evaluating the distance between the positions 10, 11, the depth at which a reflection has occurred can be determined.

FIG. 4 once again shows the situation which is produced if the fiber mat 3 has a fault as depicted in FIG. 1. Parts of the laser light 5 are likewise reflected directly at the surface 7. This part of the reflected laser light 5 again hits the row of photodiodes 6 at the basic position 10. The basic position is unchanged compared to the situation depicted in FIG. 3, provided the location of point laser 4 and row of photodiodes 6 does not change in relation to the surface 7 A further part of the laser light 5 is once again reflected below the surface 7, namely at the fiber mat 3. This part of the laser light 5 then hits the row of photodiodes 6 at a second position 12 after exiting from the rotor blade 1. FIG. 4 also does not show any effect of diffraction. The second position 12 is changed in relation to the first position 11. Thus the distance between the second position 12 and the basic position 10 also changes. If the distance is greater it can be concluded that there is a reflection which has occurred more deeply below the surface 7. This corresponds to the situation shown in FIG. 4.

Depending on the location of the point laser 4 relative to a fault in the fiber mat 3, more complex reflections can also occur so that laser light 5 will be absorbed entirely or will be reflected so that it no longer reaches the row of photodiodes 6. To obtain an overview of the location of the fiber mat 3, it is therefore expedient to measure more than just one point of the surface 7. Preferably the entire area is measured in which fiber mats 3 are present.

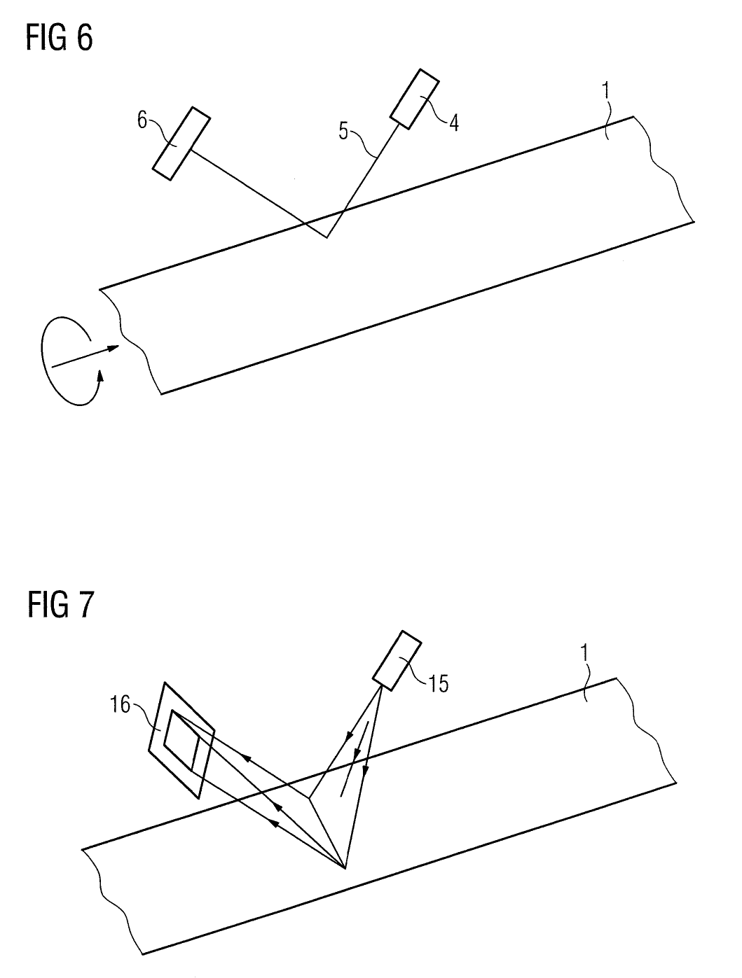

To this end it is expedient to move the rotor blade 1 relative to the point laser 4 and the row of photodiodes 6. There are a number of options for doing this. In a first embodiment variant according to FIG. 5 a displacement unit is used. This moves the point laser 4 and the row of photodiodes 6 jointly along the rotor blade 1. For this purpose the displacement unit expediently includes devices for movements along all three axes. With a movement in the x-y plane the surface 7 of the rotor blade 1 can be swept and in the z-direction the distance to the surface 7 is expediently kept constant such that for example the basic position 10 remains unchanged. In a second embodiment variant the displacement unit guides the rotor blade 1 itself while point laser 4 and row of photodiodes 6 remain fixed in one position. In a third embodiment variant which is depicted in FIG. 6, the rotor blade 1 is turned and is moved while being turned along an axis, so that the surface 7 is scanned in a similar way to an ultrasound rolling wheel sensor.

It is clear that the embodiment variants in respect of the scanning of the surface 7 are also able to be combined. Thus with a rotation of the rotor blade 1, a simultaneous movement of point laser 4 and row of photodiodes 6 can be carried out. Equally for example the rotor blade 1 can be moved in one direction and row of photodiodes 6 and point laser 4 implement the movement in the two remaining directions.

A second exemplary embodiment is sketched out in FIG. 7. By contrast with the first exemplary embodiment, the system operates here with a line laser 15 instead of a point laser 4. This generates laser light 5 which propagates in one plane. Instead of a point on the rotor blade 1, a line on the rotor blade 1 is illuminated by this method. The reflection of this line on the surface 7 of the rotor blade 1 results in a line and the reflection below the surface 7 of the rotor blade 1 results in further displaced lines or points. It is therefore the expedient to no longer use a one-dimensional row of photodiodes 6 as a detector in this case, but to use a two-dimensional resolving detector, for example a camera, for example in the form of a CCD. In the second exemplary embodiment these circumstances for the positions of 10, 11, 12 apply as in the case of the point laser 4. However ever more points are illuminated simultaneously here and several points can be examined simultaneously.

In the first exemplary embodiment considered above the assumption was made that a perceptible and measurable reflection of the laser light 5 occurred at the surface 7 itself. In this case the basic position 10 is always available for the evaluation. It is therefore also not absolutely necessary to always keep the arrangement of rotor blade 1, point laser 4 and row of photodiodes 6 the same, since a change in the arrangement makes itself evident in a change in the basic position 10. If no measurable reflection occurs at the surface 7 only the first or second position 11, 12 are available for evaluation. In this case it is expedient, for an arrangement of rotor blade 1, point laser 4 and row of photodiodes 6 which remain the same in relation to one another, to distinguish between changes in the positions 11, 12 through changing the arrangement and changes which are caused by the fiber mat 3.

In each case an evaluation of the positions of the reflected laser light 5 on scanning of the surface 7 of the rotor blade 1 produces a depth profile for the fiber mat 3. The depth profile in its turn gives the direct indication of faults or folds in the fiber mat 3 and thereby allows a deduction to be made about the quality and possible lifetime of the rotor blade 1. Using the results of the measurements as a starting point, a decision can thus be made for example about not delivering a rotor blade or taking any other measures necessary.

1.-7. (canceled)

8. An apparatus for checking the manufacturing quality for a rotor blade of a wind energy installation, featuring:
a light source for emitting light, and
a position-sensitive detection device for detection of the light, the detection device arranged outside the light path of the light.

9. The apparatus as claimed in claim 8, wherein
the light source is a laser light source

10. The apparatus as claimed in claim 8, wherein
the light source is a line light source.

11. The apparatus as claimed in claim 8, wherein
the detection device is a planar sensor.

12. A method for checking the manufacturing quality for a rotor blade of a wind energy installation, comprising:
beaming a light from a light source onto the rotor blade at an angle relative to a surface of the rotor blade, the angle not being a right angle;
receiving the light reflected from a fiber mat below the surface of the rotor blade by a detection device;
detecting the received light reflected from the fiber mat at a first position of the detection device; and
determining the location of the fiber mat from the detected position.

13. The method as claimed in claim 12, further comprising:
receiving the light reflected from the surface of the rotor blade by a detection device;
detecting the received light reflected from the surface of the rotor blade at a second position of the detection device; and
comparing the first and second positions.

14. The method as claimed in claim 13, further comprising:
moving the light source and detection device and repeating the beaming, the receiving the light reflected from the fiber mat, the detecting the received light reflected from the fiber mat, the determining, the receiving the light reflected from the surface of the rotor blade, the detecting the received light reflected from the surface of the rotor blade and the comparing.

15. The method as claimed in claim 12, further comprising:
moving the light source and detection device and repeating the beaming, the receiving, the detecting and the determining.

16. The method as claimed in claim 12, wherein the light source is a laser light source.

17. The method as claimed in claim 12, wherein the light source is a line light source.
